(19) United States
(12) Patent Application Publication
(10) Pub. No.: US 2014/0288761 A1
(43) Pub. Date: Sep. 25, 2014

(54) ENHANCED DISPLAY UNIT

(71) Applicants: Frank R. Butler, Stow, OH (US); Phillip J. Kasper, Elyria, OH (US)

(72) Inventors: Frank R. Butler, Stow, OH (US); Phillip J. Kasper, Elyria, OH (US)

(73) Assignee: BENDIX COMMERCIAL VEHICLE SYSTEMS LLC, Elyria, OH (US)

(21) Appl. No.: 13/848,916

(22) Filed: Mar. 22, 2013

(51) Int. Cl. G07C 5/08

(52) U.S. Cl. CPC G07C 5/0816
USPC 701/29.6; 701/33.2; 701/31.4; 701/31.5

(57) ABSTRACT

A diagnostic display device (DDD) receives vehicle information including diagnostic trouble codes (DTCs) over a vehicle data bus and comprises a barcode generator that generates a barcode concurrently representing a plurality of diagnostic trouble codes detected in the vehicle in which is employed. The DDD includes a display or screen on which the barcode image is presented. A technician or user can scan the barcode with a user device (e.g., a smart phone, a tablet PC, or the like), and the user device is then automatically directed to or retrieves an appropriate troubleshooting webpage or webpages on a manufacturer's website. Retrieved troubleshooting instructions, webpages, links thereto and the like are displayed to the user by the smart device and/or the display on the DDD.

### BACKGROUND

The present application finds particular application in vehicle troubleshooting systems, particularly involving diagnostic systems. However, it will be appreciated that the described techniques may also find application in other diagnostic systems, other vehicle monitoring systems, or other troubleshooting systems.

Conventional vehicle diagnostic systems include an RP1210 connector to connect a vehicle and a PC in order to facilitate troubleshooting. However, such systems are expensive and require frequent updating. Other systems include a remote diagnostic unit (RDU) or the like that couples to a vehicle data bus to read trouble codes. For example, the diagnostic unit may employ light emitting diodes (LEDs) that are illuminated in particular configurations or sequences to identify a diagnostic trouble code. Such RDUs are limited in that they can only display a single trouble code at a time (i.e., serially), which a technician then manually interprets. The technician then manually retrieves troubleshooting information corresponding thereto, e.g. via accessing a manufacturer's website and navigating to troubleshooting information associated with the trouble code. Another problem with conventional diagnostic systems is that they require frequent updating, and older diagnostic units often cannot be used with newer vehicles.

The present innovation provides new and improved systems and methods that facilitate representing multiple diagnostic trouble codes (DTCs) concurrently in a machine-readable format that facilitates automatic retrieval of troubleshooting information corresponding to the diagnostic trouble codes, which overcome the above-referenced problems and others.

### SUMMARY

In accordance with one aspect, a diagnostic display device that facilitates generating machine readable data describing vehicle status information for a vehicle comprises an interface configured to couple the diagnostic display device to a vehicle data bus and via which vehicle status information is received, a barcode generator that generates a barcode that represents the vehicle status information, and a display on which the barcode is presented for reading. In accordance with another aspect, a method of generating machine readable data describing vehicle status information for a vehicle comprises receiving vehicle status information, generating a barcode that represents the vehicle status information, and displaying the barcode on a display for scanning. The method further comprises receiving troubleshooting information responsive to the vehicle status information, and presenting the troubleshooting information to a user.

According to another aspect, a system that facilitates wireless delivery of troubleshooting information in response to received diagnostic trouble codes comprises a processor configured to receive from a mobile application a request for troubleshooting information for one or more diagnostic trouble codes detected in a vehicle, access a lookup table that correlates troubleshooting information to diagnostic trouble codes, and retrieve troubleshooting information corresponding to the one or more diagnostic trouble shooting codes. The processor is further configured to generate a troubleshooting package comprising the retrieved troubleshooting information, and transmit the trouble shooting package to the mobile application for presentation to a user.

In accordance with another aspect, a method of wireless delivery of troubleshooting information in response to received diagnostic trouble codes comprises receiving from a mobile application a request for troubleshooting information for one or more diagnostic trouble codes detected in a vehicle, accessing a lookup table that correlates troubleshooting information to diagnostic trouble codes, and retrieving troubleshooting information corresponding to the one or more diagnostic trouble shooting codes. The method further comprises generating a troubleshooting package comprising the retrieved troubleshooting information, and transmitting the trouble shooting package to the mobile application for presentation to a user.

In accordance with another aspect, an apparatus for generating machine readable data describing one or more diagnostic trouble codes for a vehicle comprises means for coupling a diagnostic display device to a vehicle and receiving at least one diagnostic trouble code, means for generating a barcode that represents the at least one diagnostic trouble code, and means for displaying the barcode for reading.

Still further advantages of the subject innovation will be appreciated by those of ordinary skill in the art upon reading and understanding the following detailed description.

### BRIEF DESCRIPTION OF THE DRAWINGS

The innovation may take form in various components and arrangements of components, and in various steps and arrangements of steps. The drawings are only for purposes of illustrating various aspects and are not to be construed as limiting the invention.

FIG. 1 illustrates a system that facilitates generating a barcode image that concurrently represents a plurality of DTCs wherein the barcode image can be scanned to facilitate automated troubleshooting information retrieval.

FIG. 2 illustrates the server in additional detail.

FIG. 3 illustrates a method for generating machine-readable data describing one or more diagnostic trouble codes for the vehicle, in accordance with various aspects described herein.

FIG. 4 illustrates a method for wireless delivery of troubleshooting information in response to received diagnostic trouble codes.

FIG. 5 illustrates a method for retrieving troubleshooting information for a plurality of diagnostic trouble codes detected vehicle, the diagnostic trouble codes being represented in barcode format.

FIG. 6 is a screenshot of a diagnostic trouble code interface or webpage provided by the manufacturer server, for use by technician in accordance with one or more aspects described herein.

### DETAILED DESCRIPTION

The foregoing problems are overcome by the herein-described systems and methods, which provide a diagnostic display device (DDD) that receives diagnostic trouble codes (DTCs) over a vehicle data bus and comprises a barcode generator that generates a barcode concurrently representing a plurality of diagnostic trouble codes detected in the vehicle in which is employed. The DDD also includes a display on which the barcode image is presented. A technician or user can then scan the barcode with a smart device (e.g., a smart phone, the tablet PC, or any other suitable device with a barcode scanner and internet connectivity), and the smart device is then automatically directed to an appropriate troubleshooting webpage or webpages on a manufacturer's website. Troubleshooting instructions, webpages, links thereto and the like can then be displayed to the user by the smart device and/or the display on the DDD.

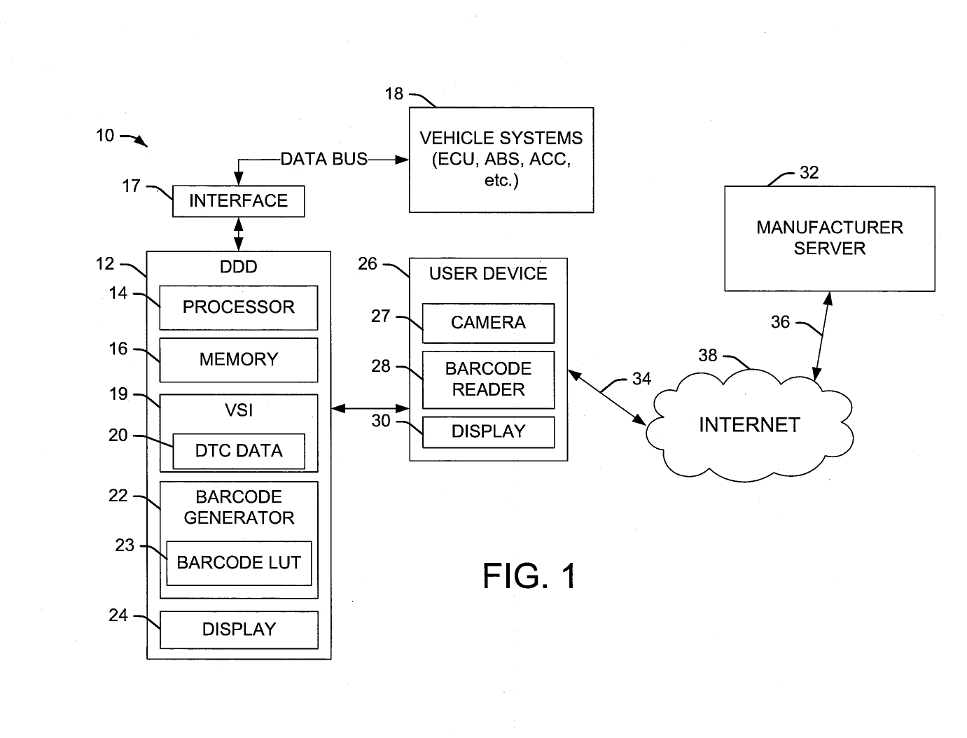

FIG. 1 illustrates a system 10 that facilitates generating a barcode image that concurrently represents vehicle status information wherein the barcode image can be scanned to facilitate automated troubleshooting information retrieval. In one embodiment, the vehicle status information encoded in the barcode comprises a plurality of DTCs. The system 10 includes a diagnostic display device 12 comprising a processor 14 that executes, and a memory 14 that stores, computer-executable instructions (e.g., modules, routines, programs, applications, etc.) for performing the various methods, techniques protocols, etc., described herein.

The memory 16 may include volatile, non-volatile memory, solid state memory, flash memory, random-access memory (RAM), read-only memory (ROM), programmable read-only memory (PROM), erasable programmable read-only memory (EPROM), electronic erasable programmable read-only memory (EEPROM), variants of the foregoing memory types, combinations thereof, and/or any other type(s) of memory suitable for providing the described functionality and/or storing computer-executable instructions for execution by the processor 14. Additionally, “module,” as used herein denotes a set of computer-executable instructions (e.g., a routine, sub-routine, program, application, or the like) that is persistently stored on the computer-readable medium or memory for execution by the processor.

The system includes an interface 17 (e.g., a 6-pin connector, a 9-pin connector, or some other suitable connector) via which the diagnostic display device is coupled to a vehicle data bus (e.g., a J1939 data bus, a J1708 data bus, or any other suitable data bus) over which diagnostic trouble codes are received from one or more vehicle systems 18 (e.g. an antilock brake system, engine control unit, cruise control system, or any other vehicle system capable of generating a fault triggers a diagnostic trouble code). The memory 16 also stores vehicle status information (VSI) 19, which may comprise one or more diagnostic trouble codes 20 received over the data bus. It will be understood that the VSI 19 is not limited to diagnostic trouble code information, but may also comprise historical vehicle diagnostic trouble code data, vehicle identification number, odometer reading, engine hours, event history, inactive diagnostic trouble codes, an all-clear status indication that indicates an absences of diagnostic trouble codes or the like, or any other suitable vehicle status information.

A barcode generator 22 is executed by the processor 14 to generate a barcode that represents the vehicle status information. In one example, the barcode concurrently represents one or more diagnostic trouble codes. For example, the barcode generator includes a barcode lookup table (LUT) 23 that correlates barcodes to diagnostic trouble codes. A barcode can be stored for each possible combination of diagnostic trouble codes that can be generated by the vehicle's systems. The barcode generator can also embed in the barcode additional vehicle information (e.g. vehicle identification number, historical diagnostic trouble code data, odometer reading, instructions for accessing troubleshooting information over the Internet, etc.)

The barcode is then displayed on a display 24 on the diagnostic display device, wherein the display 24 is readable by a mobile application, for example installed on a smart device such as a smart phone, tablet PC or the like. In one embodiment, the barcode concurrently represents multiple diagnostic trouble codes received over the data bus. The barcode may include coded information (e.g. hyperlinks, Web addresses, etc.) for directing a scanning device such as a smart phone or the like to manufacturer's server or website to facilitate retrieving troubleshooting information for the respective diagnostic trouble codes.

Once the barcode is displayed on the diagnostic display device, a user or technician then scans the barcode using user device 26 (e.g. a smart phone, Tablet PC, or any other suitable device) comprising a camera 27, a barcode reader application 28, and a display 30. Once scanned, the barcode sends the smart device to a manufacturer's website hosted by a manufacturer server 32, or directly to the server itself, via connections 34, 36 to the Internet 38. The Internet connection may be achieved by any suitable means, such as via a Wi-Fi connection to a wireless router that connects to the internet, a cellular connection, a Bluetooth™ connection, a wired connection, etc. The server 32 identifies the diagnostic trouble codes represented by the barcode, retrieves troubleshooting information for addressing the identified diagnostic trouble codes, and provides the retrieved troubleshooting information to the user device 26. The troubleshooting information may comprise, e.g. electronic documents (e.g., specific pages of a service data sheet, instructional video on troubleshooting, vehicle sensor information in graphical format, hyperlinks to any of the foregoing, etc.) Describing repair procedures, links to one or more webpages on which the electronic documents can be found, etc. In one embodiment, the retrieved troubleshooting information is displayed to the user on the user device display 30. In another embodiment the retrieved troubleshooting information is displayed to the user on the diagnostic device display 24.

It will be appreciated that the barcode generated by the diagnostic display device may be a one-dimensional (e.g. linear) barcode or may be a two dimensional barcode such as a matrix barcode, a quick response (QR) barcode, etc. In one embodiment the barcode additionally comprises priority or rank information that describes an order in which a plurality of troubleshooting information for diagnostic trouble codes represented by the barcode should be retrieved (e.g. as recommended or suggested by the manufacturer). For example, diagnostic trouble codes can be ranked according to severity of a vehicle condition represented thereby.

In one embodiment the barcode includes additional vehicle information such as historical vehicle diagnostic trouble code data and/or vehicle identification number. Such information can be compiled at the manufacturer server to identify, for example, faults that may be occurring across multiple vehicles having a common component installed thereon, having been manufactured at a common facility, or the like.

According to another embodiment, the diagnostic display device is employed as part of the Bendix® RDU diagnostic tool or trailer RDU diagnostic tool. Alternatively, the display 24 may be coupled to or mounted to the vehicle or the trailer itself and attached to the communication bus. Additionally, the diagnostic display may be integrated into an existing display on the vehicle such as the Bendix® driver interface unit or a dash display.

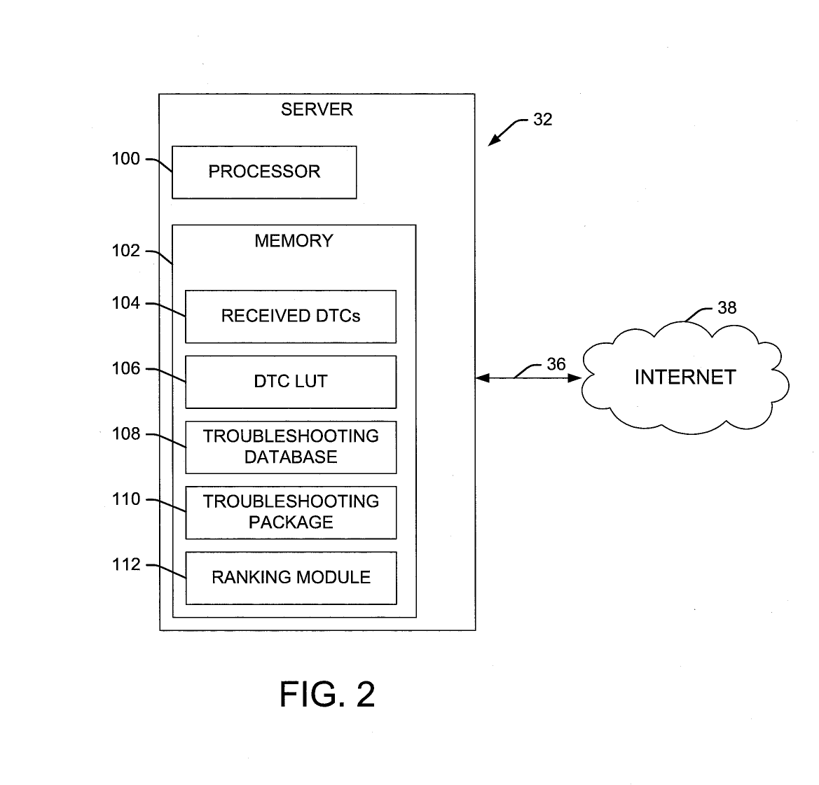

FIG. 2 illustrates the server 32 in additional detail. The server 32 is connected to the Internet 38 by connection 36 (e.g., a wired connection, and wireless connection, etc.) and comprises a processor 100 that executes, and a memory 102 that stores computer-executable instructions (e.g., modules, routines, programs, applications, etc.) for performing the various methods, techniques protocols, etc., described herein. The memory 102 may include volatile, non-volatile memory, solid state memory, flash memory, random-access memory (RAM), read-only memory (ROM), programmable read-only memory (PROM), erasable programmable read-only memory (EPROM), electronic erasable programmable read-only memory (EEPROM), variants of the foregoing memory types, combinations thereof, and/or any other type(s) of memory suitable for providing the described functionality and/or storing computer-executable instructions for execution by the processor 100.

Received diagnostic trouble codes 104 are stored in the memory 102 and the processor performs a lookup in a diagnostic trouble code lookup table 106 to identify troubleshooting information (e.g., documents, webpages, web links, etc.) corresponding to the received diagnostic trouble codes 104. The processor retrieves the identified corresponding troubleshooting information from a troubleshooting database 108 and generates a troubleshooting package comprising the identified corresponding troubleshooting information for transmission to the user device 26 (FIG. 1) and/or the diagnostic display device 12 (FIG. 1) via the Internet 38. In one example, troubleshooting package comprises one or more links to one or more webpages (e.g. hosted by the server, provided by the manufacturer, etc.) comprising troubleshooting instructions for each of the diagnostic trouble codes received from a given smart device, mobile application, etc. According to another example, the troubleshooting package comprises electronic documents comprising troubleshooting instructions for each of the diagnostic trouble codes received from a given smart device. In another example, troubleshooting package comprises a combination of the foregoing.

Additionally, the memory 102 comprises a ranking module 112 is executed by the processor to rank diagnostic trouble codes in order of importance or priority. For example, diagnostic trouble code that correlates to braking can be ranked above the diagnostic trouble code corresponding to, for instance, a faulty sensor that does not impact vehicle braking. In another embodiment, the ranking can established in an order where the first item to be fixed may result in a fix for all or a subset of the other subsequent DTCs. The processor, when generating troubleshooting package 110, presents the troubleshooting information corresponding to the higher-ranked diagnostic trouble code first, followed by the troubleshooting information corresponding to the lower-ranked diagnostic trouble code. Additionally the troubleshooting package may include instructions for the technician to address the higher-ranked diagnostic trouble code first.

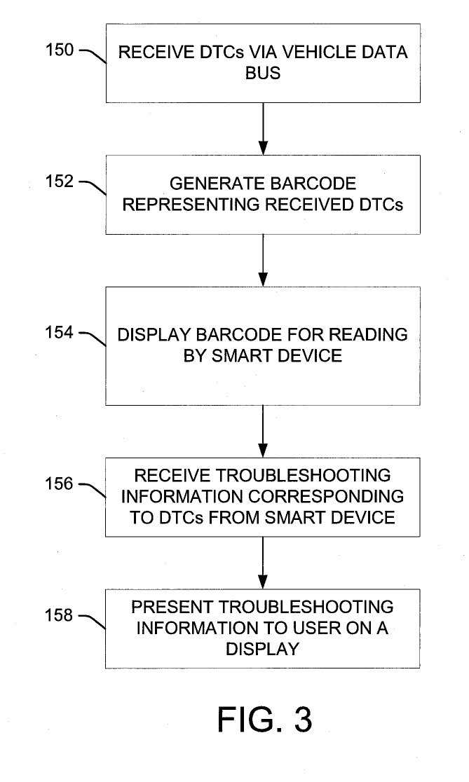

FIG. 3 illustrates a method for generating machine-readable data describing vehicle status information, which may comprise one or more diagnostic trouble codes for the vehicle, in accordance with various aspects described herein. At 150, diagnostic trouble codes are received via a vehicle data bus (e.g., a J1939 bus, a J1708 bus, or the like). At 152, a barcode is generated that represents the diagnostic trouble codes and includes information for directing the smart device that scans the barcode to a manufacturer's website or the like. In another embodiment, the smart device includes an app with all of the relevant manufacturer information. At 154, the barcode is displayed on a screen for reading or scanning by a smart device (e.g. a smart phone, a tablet PC, or any other suitable device comprising a camera, a barcode scanning app, and wireless communication capability). At 156, troubleshooting information for troubleshooting the diagnostic trouble codes is received from the smart device. At 158, the troubleshooting information is presented to a user on a display. According to one embodiment, the barcode and/or the troubleshooting information are displayed on at least one of the diagnostic display device coupled to the vehicle data bus and an onboard driver interface unit coupled to the vehicle data bus.

It will be appreciated that the barcode generated by the diagnostic display device may be a one-dimensional (e.g. linear) barcode or may be a two dimensional barcode such as a matrix barcode, a quick response (QR) barcode, etc. In one embodiment the barcode additionally comprises priority or rank information that describes an order in which a plurality of troubleshooting information for diagnostic trouble codes represented by the barcode should be retrieved (e.g. as recommended or suggested by the manufacturer) and/or addressed by the technician. For example, diagnostic trouble codes can be ranked according to severity of a vehicle condition represented thereby.

In another embodiment the barcode includes additional vehicle information such as historical vehicle diagnostic trouble code data and/or vehicle identification number. Vehicle information can be compiled at the manufacturer server to identify, for example, faults that may be occurring across multiple vehicles having a common component installed thereon, having been manufactured at a common facility, or the like.

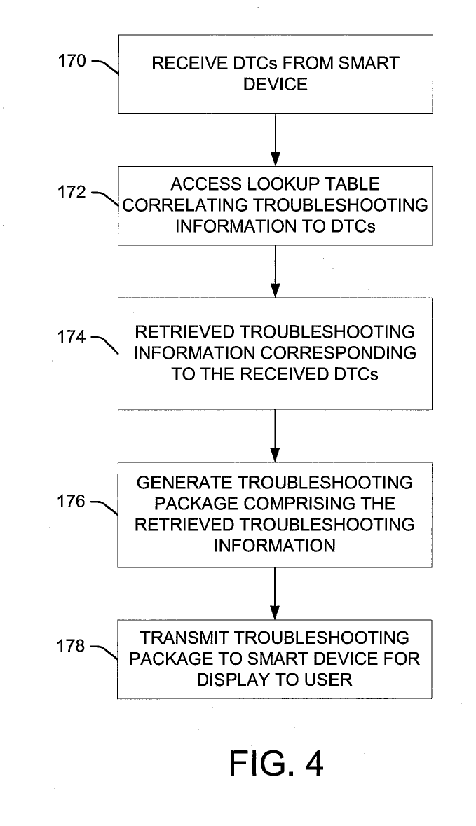

FIG. 4 illustrates a method for wireless delivery of troubleshooting information in response to received vehicle status information, which may comprise one or more diagnostic trouble codes. At 170, a request for troubleshooting information for one or more diagnostic trouble codes detected in a vehicle is received from smart device. At 172, a lookup table that correlates troubleshooting information to diagnostic trouble codes is accessed. At 174, troubleshooting information corresponding to the one or more diagnostic troubleshooting codes is retrieved. At 176, a troubleshooting package comprising the retrieved troubleshooting information is generated. At 178, the trouble shooting package is transmitted to a display via the smart device for presentation to a user. In one example the troubleshooting information is displayed on the smart device display. In another example, the troubleshooting information is displayed on a diagnostic display device coupled to the vehicle in which the trouble codes were detected. The troubleshooting package can comprise, for instance, a link to a webpage comprising the troubleshooting information for the diagnostic trouble codes. The package can also include video, PDF, audio files, etc. to assist the technician in troubleshooting.

According to one embodiment, the method further comprises ranking the received diagnostic trouble codes according to a manufacturer-recommended order in which the diagnostic trouble codes should be addressed (e.g., according to the severity of a vehicle fault condition represented by the diagnostic trouble code, etc.). In this embodiment, the troubleshooting package can include links to webpages comprising the troubleshooting information for the plurality of diagnostic trouble codes, the links being arranged in the manufacturer-recommended order. Additionally or alternatively the troubleshooting package can include information instructing the technician to address the diagnostic trouble codes in a particular order.

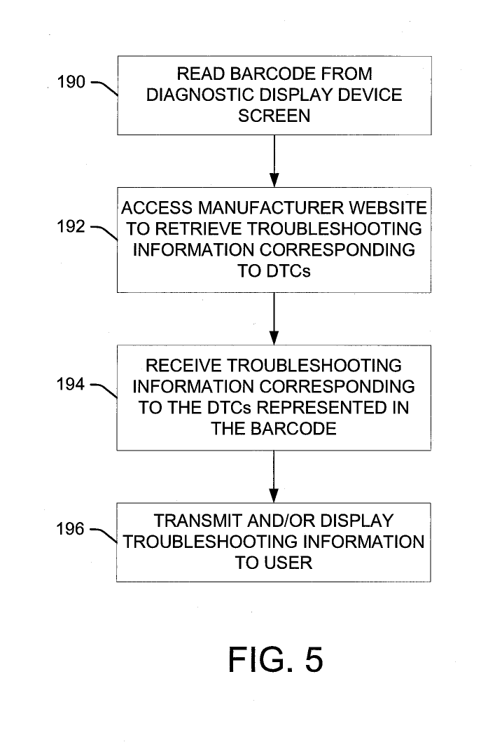

FIG. 5 illustrates a method for retrieving troubleshooting information for a plurality of diagnostic trouble codes detected vehicle, the diagnostic trouble codes being represented in barcode format. At 190, a barcode representing the diagnostic trouble codes is read (e.g. by user device such as a smartphone or tablet PC) from the screen of the diagnostic display device that is coupled to a data bus on the vehicle. The barcode additionally includes a web address, hyperlink, or other information that enables the smart device to access the manufacturer's website or database to retrieve the troubleshooting information. At 192, the manufacturer website or database is accessed to retrieve troubleshooting information corresponding to the diagnostic trouble codes represented in the barcode. At 194 troubleshooting information corresponding to the diagnostic trouble codes represented in the barcode is received at the user device from the manufacturer's website or database. At 196, the retrieved troubleshooting information is displayed on the user device and/or transmitted to a display screen in the vehicle (e.g. an onboard user interface module, the screen of the diagnostic display device, etc.).

In one embodiment the manufacturer provides an application (e.g. a mobile app or the like) that is installed on the user device. When activated by the user, the application opens a barcode scanner application with which the user scans the diagnostic trouble code barcode generated by the diagnostic display device. According to one example, the app decodes the barcode to retrieve a web address and or the diagnostic trouble codes represented by the barcode, and transmits the diagnostic trouble code information to the retrieved web address (e.g., the manufacturer's troubleshooting website). In another example, the app retrieves only the web address, accesses the manufacturer's troubleshooting website, and transmits the barcode image thereto for decoding at the manufacturer's server. In another example, the app generates an e-mail comprising the diagnostic trouble codes and sends the e-mail to the technical or customer service team that provides technical support.

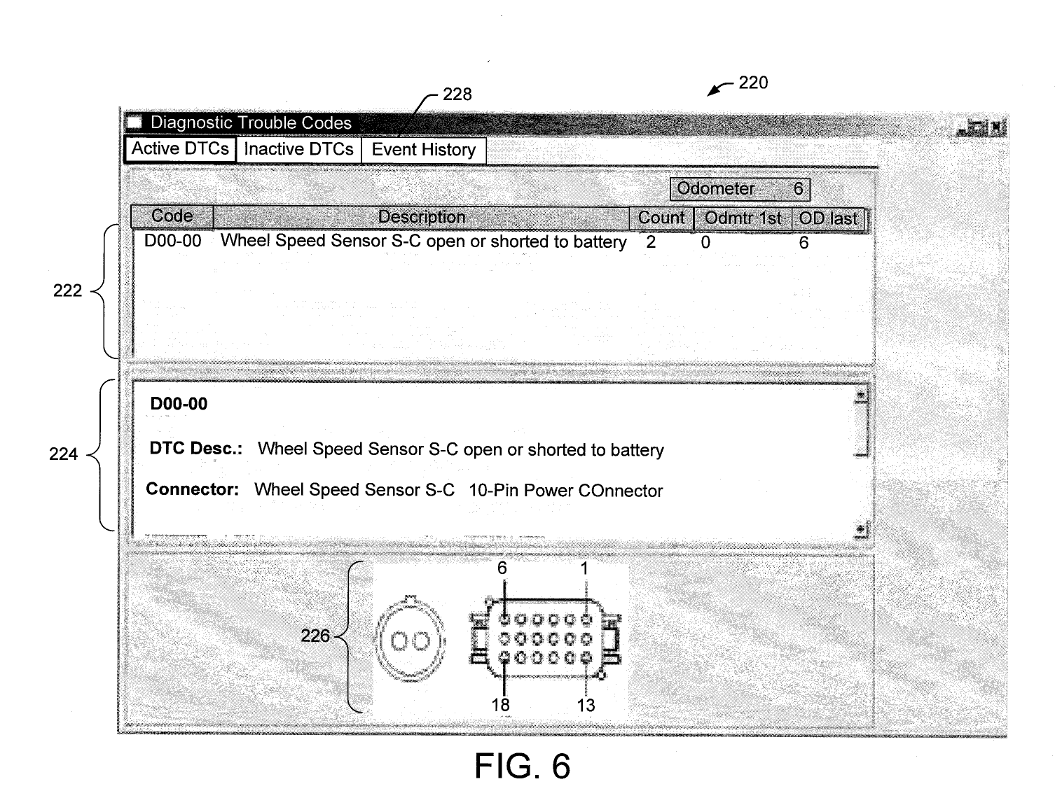

FIG. 6 is a screenshot of a diagnostic trouble code interface or webpage 220 provided by the manufacturer server, for use by technician in accordance with one or more aspects described herein. The interface is accessed for example in the technician clicks on the link provided in the troubleshooting package described herein, and provides the technician with active, inactive, and event history trouble code information. For active diagnostic trouble code information, the screen is divided into three panes in this example. The first pane 222 displays active diagnostic trouble codes; the second pane 224 displays troubleshooting/repair information corresponding to the active diagnostic trouble code; and the third pane 226 displays a connector with pin-out designations, so the technician can troubleshoot the active diagnostic trouble code. Additionally, a count of the number of occurrences of the diagnostic trouble code, the odometer readings of the first and last occurrence of the diagnostic trouble code, and the current odometer reading are provided in the example of FIG. 6. An event history screen can be accessed by clicking on an event history tab 228. The event history screen displays information for configuration change events, history of cleared events, end-of-line test completion, etc.

It will be appreciated that the interface 220 may be similar to a troubleshooting interface that, using conventional approaches, the technician would otherwise have to access manually by navigating to the manufacturer's website and serially entering diagnostic trouble codes retrieved from a remote diagnostic unit coupled to the vehicle. In contrast to such conventional approaches, the described systems and methods facilitate generating a barcode that concurrently represents multiple diagnostic trouble codes, permitting the technician to scan the barcode, and automatically retrieving the troubleshooting package including the interface 220 or a web link thereto for the technician. In this manner, the speed and efficiency vehicle troubleshooting and repair is improved and technician labor time is reduced.

The innovation has been described with reference to several embodiments. Modifications and alterations may occur to others upon reading and understanding the preceding detailed description. It is intended that the innovation be construed as including all such modifications and alterations insofar as they come within the scope of the appended claims or the equivalents thereof.

1. A diagnostic display device that facilitates generating machine readable data describing one or more vehicle status information for a vehicle, comprising:
an interface configured to couple the diagnostic display device to a vehicle data bus and via which vehicle status information is received;
a barcode generator that generates a barcode that represents the vehicle status information; and
a display on which the barcode is presented for reading;
wherein the diagnostic display device is further configured to receive ranking information associated with multiple diagnostic trouble codes included in the vehicle status information, wherein the ranking information indicates a manufacturer-recommended order in which the diagnostic trouble codes are to be addressed as a function of severity of a vehicle fault condition represented by the respective diagnostic trouble codes.

2. The diagnostic display device according to claim 1, wherein the vehicle status information includes at least one diagnostic trouble code.

3. The diagnostic display device according to claim 2, wherein the barcode concurrently represents a plurality of diagnostic trouble codes.

4. The diagnostic display device according to claim 1, wherein the barcode is a two-dimensional barcode.

5. The diagnostic display device according to claim 1, wherein the barcode is a one-dimensional barcode.

6. (canceled)

7. The diagnostic display device according to claim 1, wherein the interface is a diagnostic port on the vehicle.

8. The diagnostic display device according to claim 1, wherein the vehicle data bus is at least one of a J1939 and a J1708 data bus.

9. The diagnostic display device according to claim 1, wherein the barcode represents additional vehicle information comprising at least one of historical vehicle diagnostic trouble code data, vehicle identification number, odometer reading, engine hours, event history, inactive diagnostic trouble codes, and an all clear status indication.

10. The diagnostic display device according to claim 1, wherein the barcode is readable by a smart device comprising at least one of a smartphone and a tablet PC.

11. The diagnostic display device of claim 10, vehicle status information comprises at least one diagnostic trouble code, and wherein the smart device presents to a user troubleshooting information for resolving the at least one diagnostic trouble code.

12. A method of generating machine readable data describing vehicle status information for a vehicle, comprising:
receiving vehicle status information;
generating a barcode that represents the vehicle status information; and
displaying the barcode on a display for scanning;
receiving troubleshooting information responsive to the vehicle status information; and
presenting the troubleshooting information to a user;
wherein the troubleshooting information is presented as a list of website links comprising the troubleshooting information and ranked according to a manufacturer-recommended order as a function of severity of the vehicle status to be corrected via the troubleshooting information.

13. The method according to claim 12, wherein the vehicle status information includes at least one diagnostic trouble code.

14. The method according to claim 12, further comprising concurrently representing a plurality of diagnostic trouble codes in the barcode.

15. The method according to claim 12, wherein the barcode is a two-dimensional barcode.

16. The method according to claim 12, wherein the barcode is a one-dimensional barcode.

17. The method according to claim 12, further comprising receiving ranking information that ranks multiple diagnostic trouble codes as a function of a recommended order in which the diagnostic trouble codes are to be addressed.

18. The method according to claim 12, wherein the barcode is displayed on at least one of a diagnostic display device coupled to the vehicle data bus and a driver interface unit coupled to the vehicle data bus.

19. The method according to claim 12, wherein the vehicle data bus is at least one of a J1939 and a J1708 data bus.

20. The method according to claim 12, wherein the barcode represents additional vehicle information comprising at least one of historical vehicle diagnostic trouble code data, vehicle identification number, odometer reading, engine hours, event history, inactive diagnostic trouble codes, and an all clear status indication.

21. The method according to claim 12, wherein the troubleshooting information is presented to the user via a smart device comprising at least one of a smartphone and a tablet PC.

22. A system that facilitates wireless delivery of troubleshooting information in response to received diagnostic trouble codes, comprising:
a processor configured to:
receive from a mobile application a request for troubleshooting information for one or more diagnostic trouble codes detected in a vehicle;
access troubleshooting information that correlates to diagnostic trouble codes;
retrieve troubleshooting information corresponding to the one or more diagnostic trouble shooting codes;
generate a troubleshooting package comprising the retrieved troubleshooting information; and
transmit the troubleshooting package to the mobile application for presentation to a user
wherein the troubleshooting package comprises ranking information associated with multiple diagnostic trouble codes, wherein the ranking information indicates a manufacturer-recommended order in which the diagnostic trouble codes are to be addressed as a function of severity of a vehicle fault condition represented by the respective diagnostic trouble codes.

23. The system according to claim 22, wherein the troubleshooting package comprises a link to a webpage comprising the troubleshooting information for the one or more diagnostic trouble codes.

24. The system according to claim 22, further comprising a ranking module that is executed by the processor to rank a plurality of received diagnostic trouble codes detected in the vehicle according to a manufacturer-recommended order in which the diagnostic trouble codes are to be addressed.

25. The system according to claim 24, wherein the troubleshooting packing comprises links to webpages comprising the troubleshooting information for the plurality of diagnostic trouble codes, the links being arranged in the manufacturer-recommended order.

26. A method for wireless delivery of troubleshooting information in response to received diagnostic trouble codes, comprising:
receiving from a mobile application a request for troubleshooting information for one or more diagnostic trouble codes detected in a vehicle;
accessing troubleshooting information that correlates to diagnostic trouble codes;
retrieving troubleshooting information corresponding to the one or more diagnostic trouble shooting codes;
generating a troubleshooting package comprising the retrieved troubleshooting information; and
transmitting the trouble shooting package to the mobile application for presentation to a user;
wherein the troubleshooting package comprises ranking information associated with multiple diagnostic trouble codes, wherein the rankinq information indicates a manufacturer-recommended order in which the diagnostic trouble codes are to be addressed as a function of severity of a vehicle fault condition represented by the respective diagnostic trouble codes; and
wherein the troubleshooting information comprises a list of links to webpages for addressing the diagnostic trouble codes, wherein the list of links is ranked according to the manufacturer-recommended order in which the diagnostic trouble codes are to be addressed.

27. The method according to claim 26, wherein the troubleshooting package comprises a link to a webpage comprising the troubleshooting information for the one or more diagnostic trouble codes.

28. The method according to claim 26, further comprising ranking a plurality of received diagnostic trouble codes detected in the vehicle according to a manufacturer-recommended order in which the diagnostic trouble codes are to be addressed.

29. The method according to claim 28, wherein the troubleshooting packing comprises links to webpages comprising the troubleshooting information for the plurality of diagnostic trouble codes, the links being arranged in the manufacturer-recommended order.

30. An apparatus that facilitates generating machine readable data describing one or more diagnostic trouble codes for a vehicle, comprising:
means for coupling a diagnostic display device to a vehicle and receiving one or more diagnostic trouble code;
means for generating a barcode that represents the one or more diagnostic trouble code, wherein the one or more diagnostic trouble codes are ranked according to a manufacturer-recommended order based on the severity of the vehicle status indicated by the one or more diagnostic trouble codes; and
means for displaying the barcode for reading.
